(19) United States
(12) Patent Application Publication
(10) Pub. No.: US 2007/0116818 A1
(43) Pub. Date: May 24, 2007

(54) Extract containing beta-cryptoxanthin component from persimmon fruit

(75) Inventors: Hidehito Takahashi, Kawanishi-shi (JP); Yumiko Inada, Kawanishi-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYO SEIKAN KAISHA, LTD.

(21) Appl. No.: 11/283,827

(22) Filed: Nov. 22, 2005

(51) Int. Cl. A23L 1/27

(52) U.S. Cl. 426/540

(57) ABSTRACT

The present invention provides an extract containing a β-cryptoxanthin component from a persimmon fruit, a functional food and/or drink supplemented with the extract, and a process for producing the extract. The present invention produces the extract containing a β-cryptoxanthin component from a persimmon fruit by cutting an inexpensive raw material persimmon fruit, especially a persimmon skin, into fine pieces and extracting a β-cryptoxanthin component with an organic solvent such as ethanol. After the β-cryptoxanthin component is extracted with the organic solvent, it is preferred to eliminate the smell of dried persimmon by removing the organic solvent under reduced pressure. According to the present invention, an extract containing a β-cryptoxanthin component that does not raise consumers' anxiety even when added to foods, drinks, and the like can be produced at low cost.

### BACKGROUND OF THE INVENTION

1. Field of the Invention

The present invention relates to an extract containing a β-cryptoxanthin component from a persimmon fruit, and to a functional food and/or drink supplemented with the extract. The present invention also relates to a process for producing an extract containing a β-cryptoxanthin component from a persimmon fruit.

2. Description of the Related Art

β-cryptoxanthin, one of the carotenoids, possesses a pro-vitamin A property. It functions as an anti-carcinogenic promoter and works to quench an excess of active oxygen. Therefore, β-cryptoxanthin is attracting attention as an anti-cancer agent that also participates in intracellular signal transduction.

β-cryptoxanthin is known to be contained in a wide range of citrus fruits. There has been proposed a process for producing high-purity β-cryptoxanthin by hydrolyzing a solvent extract containing β-cryptoxanthin obtained from a precipitate of mandarin orange fruit juice and then subjecting the resulting hydrolysate to high performance liquid chromatography (Japanese Patent Application Laid-Open No. 2000-136181).

However, β-cryptoxanthin content in citrus fruits can be as low as 0.02 mg/100 g, for example, in Valencia orange fruit juice. Therefore, the industrial-scale production of β-cryptoxanthin from citrus fruits requires raw materials in large quantities and a high cost process, and as such, is not practical.

In the process described in Japanese Patent Application Laid-Open No. 2000-136181, the hydrolysate is first introduced together with a primary developing solvent into a first column filled with silica powder having an average particle size of 10 to 80 μm, to separate a fraction containing β-cryptoxanthin. Following solvent removal, the resulting fraction is introduced together with a secondary developing solvent into a second column filled with octadecylsilane silica having an average particle size of 10 to 80 μm, to separate β-cryptoxanthin. An organic solvent mainly composed of petroleum ether is used as the primary developing solvent, while an organic solvent mainly composed of acetonitrile is used as the secondary developing solvent. Thus, if the obtained β-cryptoxanthin is added to foods or drinks, consumers may be anxious about product safety.

An object of the present invention is to provide an extract containing a β-cryptoxanthin component that can be produced from an inexpensive raw material using simple steps, and to provide a process for producing the extract at a low cost. Another object of the present invention is to provide an extract containing a β-cryptoxanthin component that does not raise consumers' anxiety even when added to foods, drinks, and the like and to provide a functional food and/or drink supplemented with the extract.

### SUMMARY OF THE INVENTION

The present inventors have found that a persimmon fruit, especially a persimmon skin contains a β-cryptoxanthin component in large quantities, and have completed the present invention by using this persimmon fruit (skin) as a raw material.

The present invention adopts embodiments described in 1 to 17 below.
1. An extract containing a β-cryptoxanthin component, wherein the extract is obtained by cutting a persimmon fruit into fine pieces and extracting a β-cryptoxanthin component therefrom with an organic solvent.
2. The extract containing a β-cryptoxanthin component according to 1, wherein a persimmon skin is used as the persimmon fruit.
3. The extract containing a β-cryptoxanthin component according to 1, wherein the β-cryptoxanthin component is extracted with ethanol.
4. The extract containing a β-cryptoxanthin component according to 3, wherein the extract is intended for use in oral ingestion.
5. The extract containing a β-cryptoxanthin component according to 3, wherein the extract is adjusted to have a fixed volume by adding ethanol thereto.
6. The extract containing a β-cryptoxanthin component according to 3, wherein the β-cryptoxanthin component is extracted with ethanol, followed by elimination of the smell of dried persimmon.
7. The extract containing a β-cryptoxanthin component according to 6, wherein the β-cryptoxanthin component is extracted with ethanol, followed by elimination of the smell of dried persimmon by removing the ethanol under reduced pressure.
8. A functional food and/or drink supplemented with an extract containing a β-cryptoxanthin component for use in oral ingestion, wherein the extract is obtained by cutting a persimmon fruit into fine pieces and extracting the β-cryptoxanthin component with ethanol.
9. The functional food and/or drink according to 8, wherein the food and/or drink have a β-cryptoxanthin content of 0.1 to 50 mg/100 g.
10. A process for producing an extract containing a β-cryptoxanthin component from a persimmon fruit, comprising cutting the persimmon fruit into fine pieces and extracting the β-cryptoxanthin component therefrom with an organic solvent.
11. The process according to 10, wherein a persimmon skin is used as the persimmon fruit.
12. The process according to 10, wherein ethanol is used as the organic solvent.
13. The process according to 10, wherein the β-cryptoxanthin component is extracted with the organic solvent, followed by elimination of the smell of dried persimmon.
14. The process according to 13, wherein the β-cryptoxanthin component is extracted with the organic solvent, followed by elimination of the smell of dried persimmon by removing the organic solvent.
15. The process according to 14, wherein the β-cryptoxanthin component is extracted with the organic solvent, followed by the removal of the organic solvent under reduced pressure.
16. The process according to 15, wherein the β-cryptoxanthin component is extracted with the organic solvent, followed by the removal of the organic solvent at a temperature not higher than 65° C. under reduced pressure.
17. The process according to 13, wherein the β-cryptoxanthin component is extracted with the organic solvent, followed by elimination of the smell of dried persimmon by use of an adsorbent.
18. The process according to 14, wherein after the removal of the organic solvent, an organic solvent is freshly added to the extract and further removed.
19. The process according to 10, wherein after the β-cryptoxanthin component is extracted with the organic solvent, the resulting extracted solution is hydrolyzed to collect the β-cryptoxanthin component with an organic solvent.

### DETAILED DESCRIPTION OF THE PREFERRED EMBODIMENTS

The present invention produces an extract containing a β-cryptoxanthin component from a persimmon fruit, preferably persimmon skin. Persimmons have pH around neutral. Therefore, heating is required for processing persimmons into drinks and foods packed in containers. However, because persimmons lose their peculiar flavors and tastes when heated, they are hardly utilized as drinks and foods packed in containers. Although persimmons are domestically produced in high yields in Japan, they are not effectively utilized because most of them are left unharvested and to rot on trees. During the investigation of the effective use of persimmons, the present inventors have found that a persimmon fruit, especially persimmon skin contains β-cryptoxanthin in large quantities, and have completed the present invention.

In the present invention, a persimmon used as a raw material for producing the extract containing a β-cryptoxanthin component is not particularly limited by type, and both sweet and astringent persimmons can be used.

Examples of sweet persimmon varieties used as a raw material include Fuyu, Jiro, Amahyakume, Gosho, Hanagosho, Okugosho, Tenjingosho, Fujiwaragosho, Tokudagosho, Mikayagosho, Zenjimaru, Tohachi, Mizushima, and Shogatsu. Alternatively, examples of astringent persimmon varieties used as a raw material include Yokono, Hiratanenashi, Fuji, Saijo, Dojohachiya, Aizumishirazu, Emon, Giombo, Yotsumizo, Daiyotsumizo, Atago, Hagakushi, Kawabata, Takura, and Sakushumishirazu.

For example, the Fuyu variety contains 8.36 mg of β-cryptoxanthin per 100 g of skin. Moreover, the persimmon pulp has a β-cryptoxanthin content of 0.97 mg/100 g (see Examples 1 and 2 below) . Thus, although a preferable raw material for producing the extract containing a β-cryptoxanthin component according to present invention is a persimmon skin, a persimmon pulp can also be used as a raw material.

Hereinafter, an example of a process for producing the extract containing a β-cryptoxanthin component from a persimmon fruit by using persimmon skin as a raw material according to the present invention will be described.

The persimmon skin is peeled with a knife or the like and cut into fine pieces. The pieces are pulverized with an agitator or the like in the presence of an organic solvent and then filtered. The resulting filtrate is concentrated under reduced pressure. The resulting concentrate, from which the organic solvent has been removed, is washed with an organic solvent. Subsequently, condensation is repeated under reduced pressure until the smell of dried persimmon disappears, to yield an extract containing a β-cryptoxanthin component. The obtained extract is adjusted to have a fixed volume by optionally adding an organic solvent thereto, and then stored. In this case, cryopreservation is preferred.

The smell of dried persimmon is dissipated by performing the condensation procedures twice. Therefore, the stable extract that does not lose its flavor and taste when added to drinks and foods can be obtained.

The organic solvent used in the production of the extract is not particularly limited and includes: alcohols such as methanol, ethanol, isopropanol, and butanol; ethers such as dimethyl ether, diethyl ether, methyl ethyl ether, petroleum ether, and methyl butyl ether; ketones such as acetone, methyl ethyl ketone, and diethyl ketone; and saturated hydrocarbons such as n-hexane and n-heptane.

When the obtained extract containing a β-cryptoxanthin component is added to a product to be orally ingested such as drinks, foods, and oral pharmaceutical drugs, it is preferred to use an organic solvent such as ethanol, which does not present a health problem to the human body.

β-cryptoxanthin is present in an ester form in plants. Thus, β-cryptoxanthin is contained in an ester form in the extract produced in the above-described steps by using, for example, ethanol as the organic solvent. When the extract containing this ester form of β-cryptoxanthin is added to drinks, foods, and the like and orally ingested, the ester form is thought to be decomposed in the human body through metabolism and function therein as effective β-cryptoxanthin. Therefore, it is preferred that the extract containing a β-cryptoxanthin component that is used in such application should be produced in the above-described steps by using an organic solvent harmless to the human body such as ethanol.

For producing the extract containing a β-cryptoxanthin component that is added to a product to be orally ingested such as drinks and foods, the β-cryptoxanthin component is extracted with an organic solvent harmless to the human body such as ethanol. Preferably, the resulting extract is subsequently concentrated to remove the organic solvent such as ethanol, while the smell of dried persimmon of the extract is dissipated.

For removing the organic solvent such as ethanol, it is preferred to use a rotary evaporator or the like to perform condensation under reduced pressure. This condensation under reduced pressure allows reduction in the boiling point of the organic solvent and reduction in a condensation treatment temperature. Because the extract obtained at a condensation treatment temperature not lower than 100° C. is brown-colored, it is preferred that the condensation treatment temperature should be set to 65° C. or lower, particularly preferably 40° C. or lower.

For producing the extract free from the smell of dried persimmon, it is preferred that the organic solvent such as ethanol should be removed by volatilization under reduced pressure to concentrate the extract, to which an organic solvent such as ethanol is then added again, followed by the dissipation and removal of the organic solvent such as ethanol by condensation under reduced pressure. It is difficult to completely eliminate the smell of dried persimmon from the extract only by merely concentrating the extract to remove the organic solvent such as ethanol after the extraction of the β-cryptoxanthin component. By contrast, after the removal of the organic solvent such as ethanol and the condensation of the extract, second dilution and condensation procedures using an organic solvent such as ethanol can yield an extract free from the smell of dried persimmon. These procedures of condensation, dilution, and condensation may be repeated twice or more, if necessary.

The removal of the organic solvent such as ethanol described above does not necessarily require the complete removal of the ethanol from the extract. For this purpose, ethanol or others may be decreased to such an extent that the smell of dried persimmon disappears.

Other processes for producing the extract free from the smell of dried persimmon include, for example, a process that employs an adsorbent. For example, a solution extracted with the organic solvent such as ethanol can be allowed to pass through a column filled with an adsorbent such as active carbon to eliminate the smell of dried persimmon from the extract.

The extract containing a β-cryptoxanthin component of the present invention can be mixed, for example, in cosmetics and skin preparations for external use in a form such as cream, milky lotions, gels, and patches. Organic solvents other than ethanol can be used as an organic solvent used in the production of the extract utilized in such applications. These organic solvents are optionally removed by procedures such as condensation or replaced with a solvent harmless to human bodies such as ethanol.

For utilizing the extract in such applications, a β-cryptoxanthin component is extracted from persimmon skin or pulp with an organic solvent. Thereafter, the resulting extracted solution is supplemented with, for example, an alkali metal hydroxide and alcohol, and then hydrolyzed. Subsequently, the hydrolyzed β-cryptoxanthin component may be collected with an organic solvent to thereby produce the extract.

When the extract containing a β-cryptoxanthin component is produced by such steps, an extract containing β-cryptoxanthin in itself can be obtained. Moreover, the yield of β-cryptoxanthin can be improved.

### EXAMPLES

Next, the present invention will be described more fully with reference to Examples. The present invention is not intended to be limited to these Examples.

(Quantification of β-cryptoxanthin)

In the present invention, β-cryptoxanthin in a sample is quantified by procedures below.

For accurately quantifying elemental β-cryptoxanthin contained in a sample, methyl butyl ether is added to an extracted solution to distribute a β-cryptoxanthin component extracted from the sample into the methyl butyl ether layer, followed by saponification with a potassium hydroxide-methanol solution. Subsequently, water is added thereto to distribute unsaponified products into the methyl butyl ether layer, to which a saturated salt solution is in turn added, followed by alkali removal. Next, the methyl butyl ether layer is concentrated under reduced pressure. The resulting concentrate is adjusted in a fixed volume with methyl butyl ether to prepare a test solution to be applied to a high performance liquid chromatograph (HPLC).

This test solution is quantified by HPLC with a visible detector under analytical conditions below.

(Analytical Conditions)

Column: Carotenoid 5μ C30 (4.6 mm I.D.×250 mm) manufactured by YMC Co., Ltd.
High performance liquid chromatograph: HPLC-6A manufactured by Shimadzu Corporation
Detector: SPD-6AV manufactured by Shimadzu Corporation
Mobile phase: (A) methanol: methyl butyl ether:water:ammonium acetate=81:15:4:0.1; and (B) methanol:methyl butyl
ether:ammonium acetate=10:90:0.1
Time program: 100% A to 100% B in 90 min.
Flow rate: 1.0 ml/min.
Oven temperature: 32° C.
Detection wavelength: 450 nm
Injection volume: 20 μl
   (Creation of Calibration Curve)

Because the concentration of commercially available standard β-cryptoxanthin varies from one product to another, the creation of a calibration curve requires measuring the concentration of a standard used.

The whole quantity of standard β-cryptoxanthin (1 mg) manufactured by Aldrich is dissolved in n-hexane and adjusted to a volume of 50 ml to prepare a standard undiluted solution (approximately 20 μg/ml). A 5-ml aliquot of this standard undiluted solution is supplemented with n-hexane and adjusted to a volume of 50 ml. The absorbance of the resulting solution is measured at 451 nm. The previously reported value (E 1% 1 cm=2460) of absorption coefficient of β-cryptoxanthin is used to determine the concentration of β-cryptoxanthin in the standard solution according to the following equation:
A=E×C (%)×I cm.

In the equation, the character A designates absorbance; the character E designates absorptivity; the character C designates the molar concentration of the substance; and the character I designates the thickness of the solution layer.

After the n-hexane in the standard undiluted solution is concentrated under reduced pressure, the resulting solution is returned to the same concentration with a methyl butyl ether solvent. Next, the solution is diluted 2-, 20-, and 200-fold with methyl butyl ether. A 20-μl aliquot each of the resulting diluted solutions is subjected to HPLC to create a calibration curve from each peak area. The commercially available standard contains a slight amount of α-cryptoxanthin. Therefore, correction is conducted by the following equation:
(the peak area of β-cryptoxanthin)/(the peak area of β-cryptoxanthin+the peak area of α-cryptoxanthin).

### Example 1

The skin of the sweet persimmon variety Fuyu was peeled with a knife and cut into fine pieces. A 5-g aliquot thereof is placed in a mortar. Following the addition of 15 ml of 0.1% butylhydroxytoluene in ethanol and 1 g of silica sand, the resulting mixture was well ground and suction-filtered with a glass filter. The residue was collected and then rinsed/extracted with butylhydroxytoluene in ethanol until becoming colorless. The filtrate was transferred to a separatory funnel and supplemented with an equal amount of methyl butyl ether and a saturated salt solution. The resulting mixture was shaken to distribute a β-cryptoxanthin component into the methyl butyl ether layer. This methyl butyl ether layer was supplemented again with a saturated salt solution and shaken to distribute the β-cryptoxanthin component into the methyl butyl ether layer. The methyl butyl ether layer was then concentrated under reduced pressure. The resulting concentrate was adjusted to a volume of 20 ml with methyl butyl ether to yield an extract.

Next, 10 ml of this extract and 10 ml of 10% potassium hydroxide-methanol solution were put into a separatory funnel. The funnel was shaken under a nitrogen atmosphere and left undisturbed at room temperature for 1 hour. The solution thus saponified was supplemented with 10 ml of water to fractionate unsaponified products into the methyl butyl ether layer. Subsequently, 10 ml of a saturated salt solution was added to the methyl butyl ether layer, followed by alkali removal. The methyl butyl ether layer was concentrated under reduced pressure. The resulting concentrate was adjusted to a volume of 10 ml with methyl butyl ether. The resulting solution was filtered with a 0.2-μm membrane filter to prepare a test solution to be applied to HPLC.

A result of HPLC analysis demonstrated that the skin of the Fuyu contains β-cryptoxanthin at a concentration of 8.36 mg/100 g.

### Example 2

An extract was obtained in the same way as Example 1 except that 10 g of the pulp of Fuyu was used instead of 5 g of the skin. The quantification of a β-cryptoxanthin content in this extract demonstrated that the pulp of the Fuyu contains β-cryptoxanthin at a concentration of 0.97 mg/100 g.

### Example 3

An extract was obtained in the same way as Example 1 except that 5 g of the skin of the astringent persimmon variety Atago was used instead of 5 g of the skin of Fuyu. The quantification of a β-cryptoxanthin content in this extract demonstrated that the skin of the Atago contains β-cryptoxanthin at a concentration of 8.80 mg/100 g.

### Example 4

An extract was obtained in the same way as Example 3 except that 10 g of the pulp of Atago was used instead of 5 g of the skin. The quantification of a β-cryptoxanthin content in this extract demonstrated that the pulp of the Atago contains β-cryptoxanthin at a concentration of 0.80 mg/100 g.

### Example 5

In this Example, an extract containing a β-cryptoxanthin component intended for use in products to be orally ingested such as drinks and foods was produced in procedures below.

The skin of the persimmon variety Atago that contained 8.80 mg of β-cryptoxanthin per 100 g of the skin was peeled with a knife and further cut into fine pieces. A 23.2-g aliquot of the fine pieces was pulverized along with 50 ml of ethanol with an agitator and then filtrated. The pulverized product was washed with 150-ml of ethanol. The above filtrate and the ethanol after washing were combined and placed in a short-neck flask, which was in turn connected to an evaporator. The solution was concentrated under reduced pressure of 30 mmHg with the short-neck flask heated to 40° C. The ethanol once volatilized by the condensation under reduced pressure was cooled and collected into another container. Therefore, almost no ethanol remains in the resulting concentrate. In this condensation stage, the concentrate emitted a dried persimmon-like smell.

The concentrate was washed down and collected with 200 ml of ethanol, and transferred to another short-neck flask. The washed solution was concentrated again under reduced pressure of 30 mmHg. Since the ethanol once volatilized by this condensation procedure under reduced pressure was also cooled and collected into another container, almost no ethanol remains in the resulting concentrate. In this second condensation stage, the dried persimmon-like smell was dissipated. The concentrate attached to the bottom of the short-neck flask was transferred to a volumetric flask and then washed with ethanol. The resulting concentrate was adjusted to a volume of 200 ml by the addition of ethanol and used as the extract containing a β-cryptoxanthin component from the skin of the Atago. The adjustment of the concentrate in a fixed volume with ethanol facilitates the handling of the extract and renders its property stable. The amount of ethanol added can appropriately be increased or decreased. Alternatively, the extract may be mixed in drinks, foods, and the like, without the addition of ethanol.

When β-cryptoxanthin in the extract adjusted in a fixed volume with ethanol was quantified in the same way as above, the concentration of β-cryptoxanthin was 0.43 mg/100 ml. Accordingly, a β-cryptoxanthin content in the extract was 0.86 mg/200 ml, with the result that 0.86 mg of β-cryptoxanthin could be extracted from 23.2 g of the skin. When converted to a value per 100 g of the skin, the content was 3.71 mg/100 g, and the yield was 42.2%.

### Example 6

A concentrate containing a β-cryptoxanthin component was obtained in the same procedures as in Example 5 except that the amount of the skin of Atago used and the amount of ethanol used in extraction were changed to 2007 g and 5000 ml, respectively, and the amount of ethanol used in subsequent steps was appropriately increased. The concentrate obtained in the second condensation was supplemented with 100 g of ethanol to obtain 100 g of an ethanol extract containing 78.4 mg of β-cryptoxanthin. This extract can be mixed in drinks, foods, and the like, as with the extract of Example 5.

### Example 7

### Functional Drink Supplemented with β-cryptoxanthin Component

The quantification of a β-cryptoxanthin component contained in a Valencia orange fruit juice in the same way as above demonstrated that the fruit juice contains a β-cryptoxanthin component as low as 0.02 mg/100 g in terms of the concentration.

A 1-g aliquot of the extract containing a β-cryptoxanthin component from the skin of Atago obtained in Example 6 was added to 99 g of Valencia orange fruit juice to obtain 100 g of a fruit juice with a concentration of β-cryptoxanthin of 0.80 mg/100 g. The concentration of β-cryptoxanthin quantified after the heating of the fruit juice at 90° C. for 5 minutes was 0.63 mg/100 g, which represents 78.8% of the concentration before heating. By contrast, the β-cryptoxanthin content after heating at 90° C. for 5 minutes of Valencia orange fruit juice that was not supplemented with the extract was 0.01 mg/100 g, which represents 50% of the concentration before heating. Thus, a functional drink where β-cryptoxanthin sufficiently remains after heating can be obtained by mixing the extract containing a β-cryptoxanthin component from a persimmon skin in Valencia orange fruit juice.

When the Valencia orange fruit juice supplemented with this ethanol extract from the persimmon skin was subjected to sensory evaluation, unpleasantness was absent as compared with a fruit juice that was not supplemented with the extract.

According to the present invention, an extract containing a β-cryptoxanthin component that has an anti-cancer function and is useful as a raw material for, for example, functional drinks and foods can be produced from an inexpensive persimmon fruit using simple steps and at a low cost. Moreover, the present invention opens the door to the effective use of a persimmon fruit that has so far been unused and discarded, and as such, is an invention of great practical value.

What is claimed is:

1. An extract containing a β-cryptoxanthin component, wherein the extract is obtained by cutting a persimmon fruit into fine pieces and extracting a β-cryptoxanthin component therefrom with an organic solvent.

2. The extract containing a β-cryptoxanthin component according to claim 1, wherein a persimmon skin is used as the persimmon fruit.

3. The extract containing a β-cryptoxanthin component according to claim 1, wherein the β-cryptoxanthin component is extracted with ethanol.

4. The extract containing a β-cryptoxanthin component according to claim 3, wherein the extract is intended for use in oral ingestion.

5. The extract containing a β-cryptoxanthin component according to claim 3, wherein the extract is adjusted to have a fixed volume by adding ethanol thereto.

6. The extract containing a β-cryptoxanthin component according to claim 3, wherein the β-cryptoxanthin component is extracted with ethanol, followed by elimination of the smell of dried persimmon.

7. The extract containing a β-cryptoxanthin component according to claim 6, wherein the β-cryptoxanthin component is extracted with ethanol, followed by elimination of the smell of dried persimmon by removing the ethanol under reduced pressure.

8. A functional food and/or drink supplemented with an extract containing a β-cryptoxanthin component for use in oral ingestion, wherein the extract is obtained by cutting a persimmon fruit into fine pieces and extracting the β-cryptoxanthin component with ethanol.

9. The functional food and/or drink according to claim 8, wherein the food and/or drink have a β-cryptoxanthin content of 0.1 to 50 mg/100 g.

10. A process for producing an extract containing a β-cryptoxanthin component from a persimmon fruit, comprising cutting the persimmon fruit into fine pieces and extracting the β-cryptoxanthin component therefrom with an organic solvent.

11. The process according to claim 10, wherein a persimmon skin is used as the persimmon fruit.

12. The process according to claim 10, wherein ethanol is used as the organic solvent.

13. The process according to claim 10, wherein the β-cryptoxanthin component is extracted with the organic solvent, followed by elimination of the smell of dried persimmon.

14. The process according to claim 13, wherein the β-cryptoxanthin component is extracted with the organic solvent, followed by elimination of the smell of dried persimmon by removing the organic solvent.

15. The process according to claim 14, wherein the β-cryptoxanthin component is extracted with the organic solvent, followed by the removal of the organic solvent under reduced pressure.

16. The process according to claim 15, wherein the β-cryptoxanthin component is extracted with the organic solvent, followed by the removal of the organic solvent at a temperature not higher than 65° C. under reduced pressure.

17. The process according to claim 13, wherein the β-cryptoxanthin component is extracted with the organic solvent, followed by elimination of the smell of dried persimmon by use of an adsorbent.

18. The process according to claim 14, wherein after the removal of the organic solvent, an organic solvent is freshly added to the extract and further removed.

19. The process according to claim 10, wherein after the β-cryptoxanthin component is extracted with the organic solvent, the resulting extracted solution is hydrolyzed to collect the β-cryptoxanthin component with an organic solvent.
